(19) United States
(12) Patent Application Publication
(10) Pub. No.: US 2026/0227641 A1
(43) Pub. Date: Aug. 6, 2026

(54) Frameless eyeglasses

(71) Applicant: Michael Toulch, Montreal (CA)

(72) Inventor: Michael Toulch, Montreal (CA)

(21) Appl. No.: 19/450,662

(22) Filed: Jan. 15, 2026

Related U.S. Application Data
(60) Provisional application No. 63/753,019, filed on Feb. 3, 2025.

(51) Int. Cl. G02C 1/02; G02C 13/00

(52) U.S. Cl. CPC G02C 1/02; G02C 13/001

(57) ABSTRACT

Frameless eyeglasses including a pair of lenses provided in a substantially side-by-side relationship relative to each other each defining a lens front surface and an opposed lens rear surface and inner and outer mounting apertures extending therethrough, the inner mounting apertures being provided between the outer mounting apertures; a bridge extending between the lenses and mounted to the inner mounting apertures; a pair of side arms; and a pair of side arm connectors each mounted each to a respective one of the outer mounting apertures, each of the side arms being mounted to a respective one of the side arm connectors. The side arm connectors, the bridge or both the bridge and side arm connectors are made of a single unitary piece of folded metal.

### FIELD OF THE INVENTION

This invention relates generally to the field of eyeglasses, and more particularly to frameless eyeglasses.

### BACKGROUND OF THE INVENTION

Instead of having a rim into which lenses are inserted, rimless eyeglasses include lenses that are attached to each other through a bridge. The bridge includes a nose pad for resting the eyeglasses against the nose of an intended user. Side arms are attached to the lenses, either directly or through an end piece, or connector. The bridge and end piece are relatively small parts that need to fit tightly in relatively small apertures formed in the glasses to be secured thereto. Since these apertures are custom drilled in the lenses for each pair of eyeglasses, they often present the shape of an elongated slot with rounded ends, as they are obtained by drilling a hole in the lens and then milling an elongated slot from this hole. The typical milling and drilling machines used in the industry use a 1 mm diameter drill bit. The drilled slot will therefore necessarily have at least a 0.5 mm radius of curvature at the ends of the milled/drilled slot. Manufacturing pieces that will fit in this slot usually requires complex steps, such as soldering of coupling portions that are shaped to fit precisely in the slot to larger pieces that extend from this coupling portion. Therefore, such pieces are relatively expensive to manufacture.

Against this background, there exists a need in the industry to provide novel components for assembling rimless eyeglasses.

An object of the present invention is therefore to provide improved rimless eyeglasses components.

### SUMMARY OF THE INVENTION

In a broad aspect, there is provided frameless eyeglasses, the frameless eyeglasses defining substantially opposed eyeglasses lateral sides, the frameless eyeglasses comprising: a pair of lenses provided in a substantially side-by-side relationship relative to each other between the eyeglasses lateral sides, each one of the lenses defining a lens front surface and an opposed lens rear surface, each one of the lenses defining an inner mounting aperture and an outer mounting aperture extending therethrough between the lens front and rear surfaces, the outer mounting apertures being provided at the eyeglasses lateral sides, and the inner mounting apertures being provided between the outer mounting apertures; a bridge extending between the lenses and mounted to the inner mounting apertures; a pair of side arms; and a pair of side arm connectors each mounted each to a respective one of the outer mounting apertures, each of the side arms being mounted to a respective one of the side arm connectors; wherein the side arm connectors or the bridge or both the bridge and the side arm connectors are made of a single unitary piece of folded metal.

There may also be provided frameless eyeglasses wherein the side arm connectors and the bridge are each made of a single unitary piece of folded metal.

There may also be provided frameless eyeglasses wherein the side arm connectors and the bridge define mounting portions secured in a respective mounting aperture selected from the inner and outer mounting apertures, each side arm connector defining one of the mounting portions and the bridge defining a pair of spaced apart mounting portions.

There may also be provided frameless eyeglasses wherein the mounting portions are secured in the respective mounting apertures in a glueless and gasketless joint.

There may also be provided frameless eyeglasses wherein the mounting portions directly contact the lenses in the respective mounting apertures.

There may also be provided frameless eyeglasses wherein the mounting portions define thread segments and wherein the mounting portions are secured in the respective aperture through threaded fasteners engaging both the thread segments and the lenses.

There may also be provided frameless eyeglasses wherein the fasteners engage the thread segments along a first circumferential portion of the fasteners and engage the lenses along a remainder of a circumference of the fasteners.

There may also be provided frameless eyeglasses wherein the mounting portion is made of folded sheet metal defining two sheet metal faces and a sheet metal edge extending therebetween, the thread segments being formed in one of the sheet metal faces.

There may also be provided frameless eyeglasses wherein the mounting portion is made of folded sheet metal defining two sheet metal faces and a sheet metal edge extending therebetween, the threads being formed in the sheet metal edge.

There may also be provided frameless eyeglasses wherein the mounting portion is substantially U-shaped and defines a pair of substantially parallel arms extending through the respective mounting aperture and a base extending therebetween, the base being in front of the lenses.

There may also be provided frameless eyeglasses wherein the arms flare laterally outwardly opposed to the base.

There may also be provided frameless eyeglasses wherein a slit extends through the mounting portion along the arms and the base.

There may also be provided frameless eyeglasses wherein the inner and outer mounting apertures are each substantially oval shaped.

There may also be provided frameless eyeglasses wherein the inner and outer mounting apertures are each shaped as an intersection of an oval shaped main portion and a disc-shaped fastener receiving portion intersecting the main portion, and wherein the side arm connectors each define a fastener receiving recess receiving a threaded fastener thereinto, the fastener receiving portion and the fastener receiving recess being concentric.

There may also be provided frameless eyeglasses wherein the inner and outer mounting apertures are each shaped as an intersection of an oval shaped main portion and a disc-shaped fastener receiving portion intersecting the main portion, and wherein the side arm connectors each define a fastener receiving recess receiving a threaded fastener thereinto, the fastener receiving portion and the fastener receiving recess being eccentric relative to each other.

There may also be provided frameless eyeglasses wherein the bridge defines a pair of nose pad supports and wherein a nose pad is are attached to each of the nose pad supports.

In another broad aspect, there is provided a frameless eyeglasses components kit for assembling eyeglasses defining substantially opposed eyeglasses lateral sides using a pair of lenses, wherein with the lenses provided in a substantially side-by-side relationship relative to each other between the eyeglasses lateral sides, each one of the lenses defines a lens front surface and an opposed lens rear surface, each one of the lenses defining an inner mounting aperture and an outer mounting aperture extending therethrough between the lens front and rear surfaces, the outer mounting apertures being provided at the eyeglasses lateral sides, and the inner mounting apertures being provided between the outer mounting apertures, the frameless eyeglasses components kit comprising: a bridge mountable to both inner mounting apertures; a pair of side arms; and a pair of side arm connectors each mountable to a respective one of the outer mounting aperture, each of the side arms being mountable to a respective one of the side arm connectors; wherein at least one of the side arm connectors and the bridge is made of a single unitary piece of folded metal.

Advantageously, the use of folded metal allows one to manufacture the side arm connectors and bridge relatively easily at relatively low cost.

The present application incorporates by reference in its entirety the priority document, U.S. provisional patent application 63/753,019 filed Feb. 3, 2025 by Toulch.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective view, illustrate eyeglasses in accordance with an embodiment of the present invention;

FIG. 2, in a perspective view with hidden lines shown, illustrates how side arm connectors and a bridge are attached to lenses in the eyeglasses of FIG. 1;

FIG. 3A to 3E, in perspective views, illustrate successive steps in manufacturing of the side arm connector of the eyeglasses of FIG. 1;

FIG. 4A to 4E, in top elevation views, illustrate steps corresponding respectively to FIGS. 3A to 3E;

FIG. 5, in a perspective view, illustrates the bridge of the eyeglasses shown in FIG. 1;

FIG. 6A to 6G, in perspective views, illustrate successive steps in manufacturing of the bridge of the eyeglasses of FIG. 1;

FIG. 7A to 7G, in top elevation views, illustrate steps corresponding respectively to FIGS. 6A to 6G;

FIG. 8, in a perspective view, illustrates an alternative side arm connector usable in eyeglasses similar to the eyeglasses of FIG. 1;

FIG. 9, in a perspective view, illustrates an attachment portion part of the side arm connector of FIG. 8;

FIG. 10, in a perspective view, illustrates a connector blank usable to manufacture the side arm connector of FIG. 8;

FIG. 11, in a perspective view, illustrates assembly of the side arm connector of FIG. 8 to a lens;

FIG. 12, in a perspective view, illustrates an alternative bridge usable in eyeglasses similar to the eyeglasses of FIG. 1;

FIG. 13, in a perspective view, illustrates a bridge blank usable to manufacture the bridge of FIG. 12;

FIG. 14, in a front elevation view, illustrates an alternative embodiment of frameless eyeglasses;

FIG. 15, in a front elevation view, illustrates a mounting aperture formed in the lenses of the eyeglasses of FIG. 14;

FIG. 16, in a perspective view, illustrates a side arm connector part of the eyeglasses of FIG. 14;

FIG. 17, in a perspective view, illustrates a bridge part of the eyeglasses of FIG. 14;

FIG. 18, in a perspective view, illustrates yet another embodiment of a connector;

FIG. 19, in a side elevation view, illustrates the connector of FIG. 18 engaged with an alternative threaded fastener;

FIG. 20, in a perspective view, illustrates the connector of FIG. 18 attached to a lens using the connector of FIG. 19;

FIG. 21, in a cross-sectional view midway axially through the connector, illustrates an engagement of the connector, fastener and lens of FIGS. 18 to 20.

FIG. 22, in a perspective view, illustrates yet another alternative embodiment of frameless eyeglasses;

FIG. 23, in a perspective view, illustrates a side arm connector part of the eyeglasses of FIG. 22;

FIG. 24, in a front elevation view, illustrates a mounting aperture formed in the lenses of the eyeglasses of FIG. 22;

FIG. 25, in a rear elevation view, illustrates the side arm connector of FIG. 23 mounted in the mounting aperture of FIG. 24;

FIG. 26, in a rear elevation view, illustrates the side arm connector of FIG. 23 mounted in the mounting aperture of FIG. 24 with a threaded fastener engaging the side arm connector and the lens in which the mounting aperture is formed;

FIG. 27, in a perspective exploded view, illustrates yet another alternative embodiment of a side arm connector;

FIG. 28, in a perspective view, illustrates the side arm connector of FIG. 27;

FIG. 29, in a perspective view, illustrates the side arm connector of FIG. 27 assembled to a lens;

FIG. 30, in a perspective cut-away view, illustrates the side arm connector of FIG. 27 assembled to a lens;

FIG. 31, in a perspective view, illustrates yet another alternative embodiment of eyeglasses, the eyeglasses of FIG. 31 including a frame;

FIG. 32, in a perspective exploded view, illustrates attachment of the side arm connector of FIG. 28 to the frame of FIG. 31;

FIG. 33, in an alternative perspective exploded view, illustrates attachment of the side arm connector of FIG. 28 to the frame of FIG. 31;

FIG. 34, in a perspective view, illustrates an alternative side arm connector and side arm usable in the eyeglasses of FIG. 22;

FIG. 35, in a partial exploded view, illustrates the side arm connector and side arm of FIG. 34;

FIG. 36, in a perspective cut away view, illustrates the side arm connector of FIG. 34 mounted to a lens with the side arm mounted to the side arm connector;

FIG. 37, in a front elevation view, illustrates a fastener mounted eccentrically in a mounting portion of an outer mounting aperture;

FIG. 38, in a perspective view, illustrates eyeglasses incorporating the side arm connector of FIG. 34;

FIG. 39, in a perspective view, illustrates the boxed portion of FIG. 38;

FIG. 40, in a front elevation view, illustrates the eyeglasses of FIG. 38;

FIG. 41, in a rear elevation view, illustrates the eyeglasses of FIG. 38;

FIG. 42, in a front elevation view, illustrates the boxed portion of FIG. 40;

FIG. 43, in a rear elevation view, illustrates the boxed portion of FIG. 42;

FIG. 44, in a top plan view, illustrates the eyeglasses of FIG. 38;

FIG. 45, in a top plan view, illustrates the boxed portion of FIG. 44;

FIG. 46, in a bottom plan view, illustrates the eyeglasses of FIG. 38;

FIG. 47, in a bottom plan view, illustrates the boxed portion of FIG. 46;

FIG. 48, in a side elevation view, illustrates the eyeglasses of FIG. 38; and

FIG. 49, in a side elevation view, illustrates the boxed portion of FIG. 48.

### DETAILED DESCRIPTION

The term “substantially” is used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention. These variations are to be interpreted from the point of view of the person skilled in the art.

Directional terminology, such as top and bottom, among others, refers to the orientation relative to an upstanding user wearing the eyeglasses with eyes facing the horizon. This terminology is used for clarity reasons and should not be used to unduly restrict the scope of the invention.

In the following detailed description of the invention, similar features in the figures have been given similar reference numerals, and in order not to weigh down the figures, some elements are not referred to in some figures if they were already identified in another figure.

Referring to FIG. 1, there are shown eyeglasses 10. The eyeglasses 10 define substantially opposed eyeglasses lateral sides 12 and 14. The eyeglasses 10 include a pair of lenses 16 and 18 provided in a substantially side-by-side relationship relative to each other between the eyeglasses lateral side 12 and 14. The eyeglasses 10 also include a bridge 20 extending between the lenses 16 and 18, a pair of side arm connectors 26 and 28 each mounted each to a respective one of the lenses 16 and 18, and a pair of side arms 22 and 24 each mounted to a respective one of the side arm connectors 26 and 28.

At least one of the side arm connectors 26 and 28 and the bridge 20, and typically both the side arm connectors 26 and 28 and the bridge 20, are made of a single unitary piece of folded metal. Such a piece of folded metal is manufactured without the use of welds or other joints between different portions of any given component. For example, the folded metal is sheet metal, that has been suitable stamped.

Each lens 16 and 18 defines a lens front surface 30 and an opposed lens rear surface 32. Also, each lens 16 and 18 defines an inner mounting aperture 34 and an outer mounting aperture 36 extending therethrough between the lens front and rear surfaces 30 and 32. The outer mounting apertures 36 are provided at the eyeglasses lateral sides 12 and 14, and the inner mounting apertures 34 are provided between the outer mounting apertures 36, typically laterally opposed to the outer mounting apertures 36 relative to each lens 16 and 18. The end portions 38 and 40 are half-disc shaped and the intermediate portion is rectilinear.

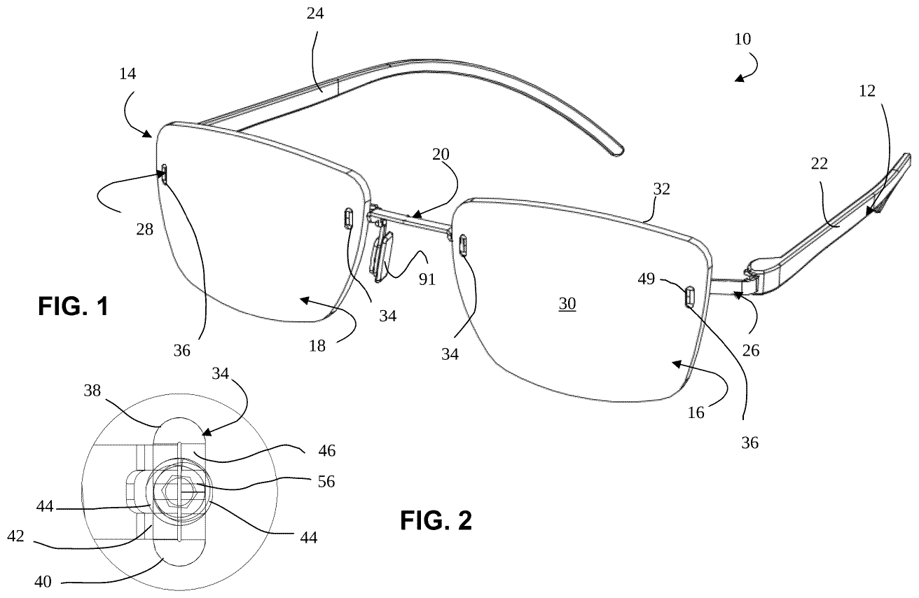

The inner and outer mounting apertures 34 and 36 are substantially similar to each other. In some embodiments, as better seen in FIG. 2 for the inner mounting aperture 34, each of the inner and outer mounting apertures 34 and 36 is substantially elongated and defines a pair of opposed end portions 38 and 40 and an intermediate portion 42 therebetween. The end portions 38 and 40 are half-disc shaped and the intermediate portion is substantially rectilinear.

In some embodiments, the intermediate portion 42 is provided with a pair of arcuate recesses 44 extending laterally therefrom. The arcuate recesses 44 are for example facing each other across the intermediate portion 42 and may be threaded or smooth. The arcuate recesses 44 are shaped so as to lie on a common imaginary cylinder having a central axis passing through the intermediate portion 42.

These arcuate recesses are manufactured by drilling through the lenses 16 and 18 with a drill bit having a diameter larger than the width of the remainder of the intermediate portion 42 at a suitable location relative to the latter. In this configuration, the inner and outer mounting apertures 34 and 36 are each shaped as an intersection of an oval shaped main portion (including most of the intermediate portion 42 and both end portions 38 and 40 and a disc-shaped fastener receiving portion intersecting the main portion corresponding to the space used by the drill bit used to form the arcuate recesses 44.

The drill bit used to manufacture the fastener receiving portion, and therefore the arcuate recesses 44, may be concentric with the recess 54, as seen in FIG. 2, or eccentric relative thereto, as seen in FIG. 37. In FIG. 37, the side arm connector 26 had been omitted to clearly show the lack of contact between the threaded fastener 56 and part of the arcuate segments 44, at the top of the fastener. The empty portions of the oval shape are in reality filled a mounting portion 46 part of the side arm connector 26, which is symmetrical in along a plane perpendicular to the outer mounting aperture 36. In this latter case part of the circumference of the threaded fastener 56 is therefore disengaged from the lenses 16 and 18. This may be useful to reduce stress in the relatively soft material of the lenses 16 and 18, when compared with the case in which the whole circumference of the threaded fastener 56 engages either the side arm connector 26 or 28 or the lens 16 or 18.

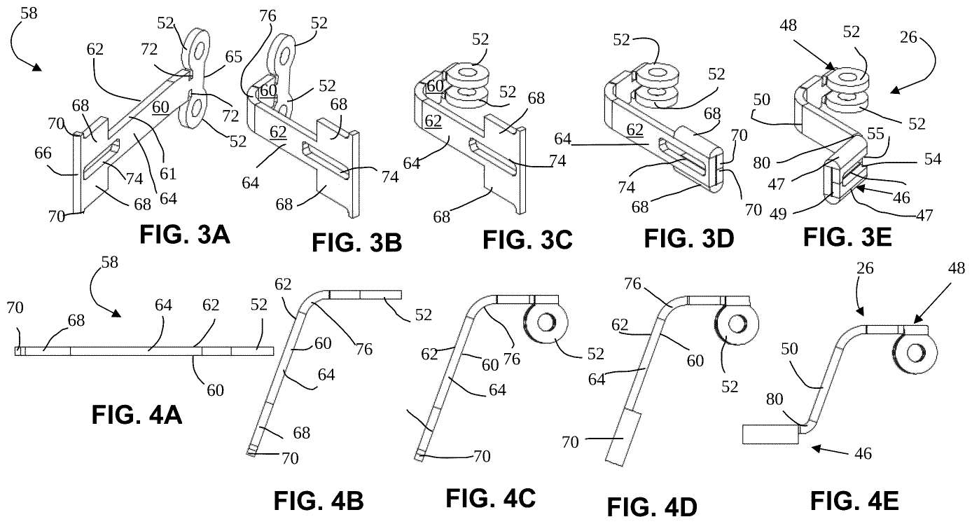

The side arm connectors 26 and 28 each include a mounting portion 46, a side arm attachment 48 and a spacing portion 50 extending therebetween, as seen in FIG. 3E for the side arm connector 26. In the embodiment shown in the drawings, the other side arm connector 28 is similar to the side arm connector 26 and is therefore not described in details. The mounting portion 46 is shaped to conform to the shape of the outer mounting aperture 36, except for clearing the arcuate recesses 44, so as to be substantially snugly insertable thereinto. The side arm attachment 48 includes for example a pair of vertically spaced apart horizontal eyelets 52 usable to pivotally mount thereto a side arm 22 or 24 defining pins configured and sides to engage the eyelets 52. Such pins are well-know in the art and not further described herein. The side arms 22 and 24 may also be removably mounted to the side arm connectors 26 and 28 is the pins and/or the eyelets 52 are sufficiently compliant. The spacing portion 50 is shaped so that the eyelets 52 are positioned laterally outwardly relative to the outer mounting apertures 36, so that the side arms 22 and 24 are positioned laterally outwardly relative to the lenses 16 and 18.

In a specific embodiment of the invention, the mounting portion 46 defines a recess 54. The recess 54 is laterally open in register with the arcuate recesses 44 and defines threaded upper and lower surfaces 55 and 57 that also lie on the surface of the imaginary cylinder defining the arcuate recesses 44, so that a threaded fastener 56 (seen for example in FIG. 2) can engage simultaneously the arcuate recesses 44 in the lenses 16 and 18 and the upper and lower surfaces 55 and 57 in the mounting portion 46. The term “threaded” as it relates to the upper and lower surfaces 55 and 57 refers to the presence of grooves, or thread segments, on these two surfaces that are all located at the locus of a common helical thread corresponding in dimensions and configuration to the thread of the threaded fastener 56. This engagement of the threaded fastener to both the mounting portion 46 and one of the lenses 16 or 18 secures the mounting portion 46 in the inner and outer mounting apertures 34 and 36. Thus, the threaded fasteners 56 engage these thread segments along a first circumferential portion of the threaded fastener 56 and engage the lenses 16 and 18 along a remainder of a circumference of the threaded fasteners 56. In alternative embodiments, threads are not used and the mounting portion 46 is secured to the eyeglasses through friction or using an adhesive.

The mounting portion 46 is substantially U-shaped and defines a pair of substantially parallel arms 47 extending through the outer mounting aperture 36 and a base 49 extending therebetween, the base 49 being in front of the lenses 16 and 18, as seen in FIG. 1.

In the embodiment shown in the drawings, the mounting portion 46 is secured in its respective outer mounting aperture 36 in a glueless and gasketless joint. This creates a joint in which the mounting portions 46 directly contact the lenses 16 and 18 in the outer mounting apertures 36. This is to be contrasted to many conventional mounting methods in which components are inserted in apertures of lenses using a gasket or glue, which may make difficult removal of the component without causing damage to the lens, and which also typically create a small aura around the junction with the lens presenting an aesthetically unpleasant aspect.

The side arm connectors 26 and 28 are formed of folded sheet metal as illustrated in the sequence of FIGS. 3A to 3E and 4A to 4E. First, as seen in FIGS. 3A and 4A, a connector blank 58 is provided. The connector blank 58 is substantially planar and defines opposed connector blank first and second surfaces 60 and 62 and a connector blank side edge 61 extending therebetween. The connector blank 58 is substantially elongated and defines a rectilinear connector backbone 64 having backbone first and second ends 65 and 66. A pair of wings 68 extend laterally from the connector backbone 64 at the backbone second end 66. The wings 68 are substantially rectangular and laterally flared at the backbone second end 66 to define wing protrusions 70 protruding laterally from the remainder of the wings 68. The eyelets 52 protrude laterally from the backbone 68 at the backbone first end 65. In some embodiments, a pair of notches 72 extend laterally inwardly in the connector backbone 64 adjacent the eyelets 52. An elongated slit 74 extends longitudinally along the connector backbone 64 between the connector blank first and second surfaces 60 and 62 adjacent the wings 68. The slit 74 extends further than the wings 68 towards the backbone first end 65 and ends in laterally in register with the protrusions 70 at the backbone second end 66.

To form the side arm connector 26 from the connector blank 58, one may perform the following steps. First, as seen in FIGS. 3B and 4B, a first bend 76 is formed in the connector backbone 64 so that the connector blank first surface 60 is concave at the first bend 76. Then, the eyelets 52 are bent towards each other towards the connector blank first surface 60 adjacent the notches 72 so as to become substantially parallel to each other, as seen in FIGS. 3C and 4C. In the next step, the wings 68 are folded over the connector backbone 64 on the connector blank first surface 60. The wings 68 are sized such that the protrusions 70 abut against each other or are only very slightly spaced apart from each other after this step, as seen in FIGS. 3D and 4D. In the last folding step, the configuration of FIGS. 3E and 4E is obtained by folding the connector backbone 64 at a second bend 80 so that the connector blank second surface 62 is concave. The second bend 80 if made at a location overlapping the slit 74.

After this last bending step, the recess 54 is formed. Indeed, since the connector backbone 64 has been folded in the slit 74, after bending, access along the longitudinal axis of the slit 74 is provided. The slit 74 and the gap between the folded wings 68 form the upper and lower surfaces 55 and 57 of the recess 54, which is terminated by the protrusions 70 and the end of the slit 74 adjacent the backbone second end 66. Therefore, a substantially U-shaped recess 54 is formed. The upper and lower surfaces 55 and 57 can then be threaded. It should be noted that due to the manner in which the side arm connector 26 is formed, threads of the recess 54 are formed in the edge of the sheet metal used to form the connector blank 58 so that these threads are generally close to perpendicular to the connector blank first and second surfaces 60 and 62, with a slight angle relative thereto corresponding to the pitch of these threads. This differs markedly from conventional threads that are formed in an aperture extending through sheet metal in which the threads are nearly parallel to the two surfaces of the sheet metal. In some embodiments, these threads can therefor be stamped or cut directly into the connector blank 58, which removes another step in the manufacturing process. In such embodiments, the side arm connector 26 is formed purely by the cutting and folding process, without requiring any tapping.

The reader skilled in the art will appreciate that alternative folding sequences are also possible. An advantage of the present folding configuration is that once the side arm connector 26 has been formed, there are no sharp edges at the interface between the side arm connector 26 and the lenses 16 and 18. Such sharp edges are to be avoided as the relatively hard sheet metal of the side arm connector 26 could damage the lenses 16 and 18, which are typically made of a relatively soft polymer, if sharp edges were to contact the lenses 16 and 18. Indeed, the connector blank 58 is typically formed by stamping or laser cutting, which leaves relatively sharp edges at the interface between the connector blank first and second surfaces 60 and 62 and the connector blank side edge 61. Due to the folding process, these sharp edges are hidden in the mounting portion 46, so that the latter externally presents rounded edges that can closely match the shape of the outer mounting apertures 36.

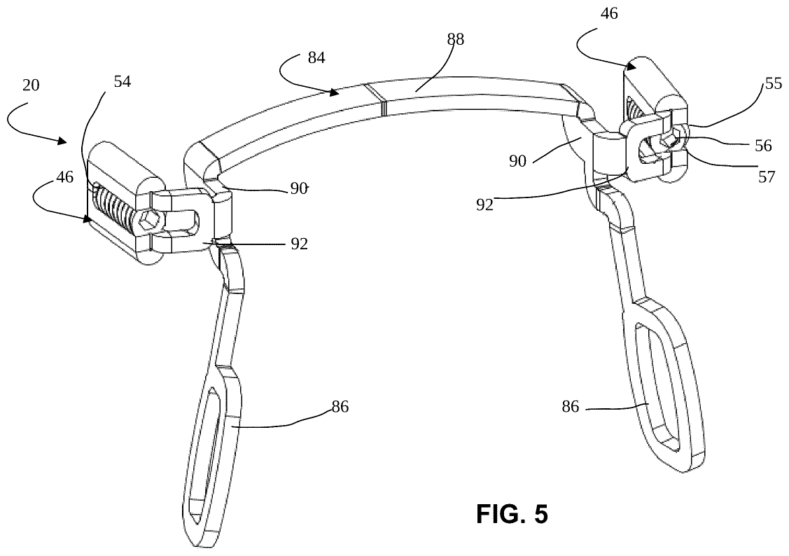

Referring to FIG. 5, the bridge 20 includes a pair of laterally spaced apart mounting portions 46 similar to the mounting portion 46 of the side arm connectors 26 and 28, a central portion 84 extending between the mounting portions 46, and a pair of nose pad supports 86 extending from the central portion 84. The central portion 84 is substantially U-shaped and includes a central base 88 from which a pair of legs 90 extend generally downwardly at each lateral end thereof. The nose pad supports 86 each extend downwardly from a respective one of the legs 90 and are substantially d-shaped so as to allow attachment thereto of a conventional nose pad 91 (as shown In FIG. 1 for example). The mounting portions 46 are generally parallel to or form only a small angle with the legs 90 and are spaced apart laterally therefrom by a linking segment 92 extending between each leg 90 and a respective one of the mounting portions 46. Other suitable shapes of bridges are usable in alternative embodiments of the invention.

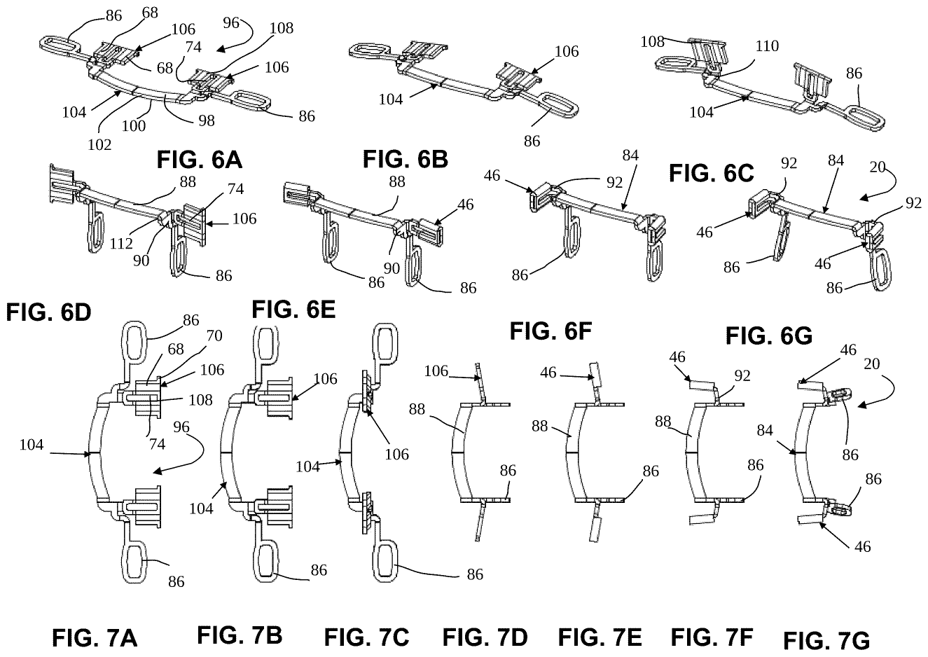

The bridge 20 is formed of folded sheet metal as illustrated in the sequence of FIGS. 6A to 6G and 7A to 7G. First, as seen in FIGS. 6A and 7A, a bridge blank 96 is provided. The bridge blank 96 is substantially planar and defines opposed bridge blank first and second surfaces 98 and 100 and a bridge blank side edge 102 extending therebetween. The bridge blank 96 includes a blank main portion 104 including the material that will form the central base 88 and legs 90, the nose pad supports 86 and a pair of connecting sections 106 including the material will form the mounting portions 46 and the linking segments 92. The nose pad supports 86 and the connecting sections 106 extend from the blank main portion 104 so that the nose pad supports 86 and the connecting sections 106 are generally perpendicular to each other and can be bent independently from each other relative to the blank main portion 104. Also, the nose pads supports 86 and the blank main portion 104 are generally parallel to each other. The connection between the nose pad supports 86 and the blank main portion 104 is also typically relatively narrow so that the nose pad supports 86 can be rotated about the plane of the bridge blank 96 relatively easily to orient the nose pad supports to conform with the shape of a human nose. The connecting sections 106 each include a bridge backbone 108 from which wings 68 defining protrusions 70 extend, similarly to the manner the wings 68 and protrusions 70 extend from the connector backbone 64. Also, a slit 74 is formed in the bridge backbone 108, similarly to the slit 74 of the connector backbone 64.

To form the bridge 20, one may perform the following steps. First, as seen in FIGS. 6B and 7B, the blank main portion 104 is bent slightly at its lateral ends so that the nose part supports 86 and connecting sections 106 together remain coplanar and are angled relative to the blank main portion 104. Then, as seen in FIGS. 6C and 7C, the bridge backbones 108 are bent adjacent the slit 74 so that the segment of the bridge backbone 108 containing the slit 74 becomes about perpendicular to the blank main portion 104, creating a concave crease 110 in the bridge blank first surface 98. Afterwards, the blank main portion 104 is bent at the lateral extremities of the blank main portion 104 so that the legs 90 are defined, creating a concave crease 112 in the bridge blank second surface 100, as seen in FIGS. 6D and 7D, followed by formation of the mounting portions 46 by folding the wings 68, similarly to the way the mounting portions are formed the side arm connector 26, to achieve the configuration of FIGS. 6E and 7E. The connecting sections 106 are then further bent at the intersection of the mounting portions 46 and spacing segments 92, at a location including the slit 74, as seen in FIGS. 6F and 7F. The nose pad supports 86 are then slightly bent to flare away from each other in a direction leading away from the blank main portion 104 and be rotated to adopt the conventional nose pad support configuration. It should be noted that once this process has been completed, and once the eyeglasses 10 are assembled, the central base 88 will be viewed from the edge of the sheet metal used to manufacture the bridge 20 when the eyeglasses are worn. This configuration leads to a highly unobstructive bridge 20 that has a small visual signature.

The side arm connectors 26 and 28 and the bridge 20 can then be used to assemble the eyeglasses 20. The inner and outer mounting apertures 34 and 36 are typically custom drilled in the lenses 16 and 18 as the latter usually have different curvatures in the lens front and rear surfaces 30 and 32, depending on the corrective power of the lenses 16 and 18. Once the inner and outer mounting apertures 34 and 36 have been formed, the mounting portions 46 are inserted thereinto and the threaded fastener 56 are used to secure the mounting portions 46 and the lenses 16 and 18 to each other by screwing the threaded fasteners 56 in the recesses 54 and arcuate recesses 44.

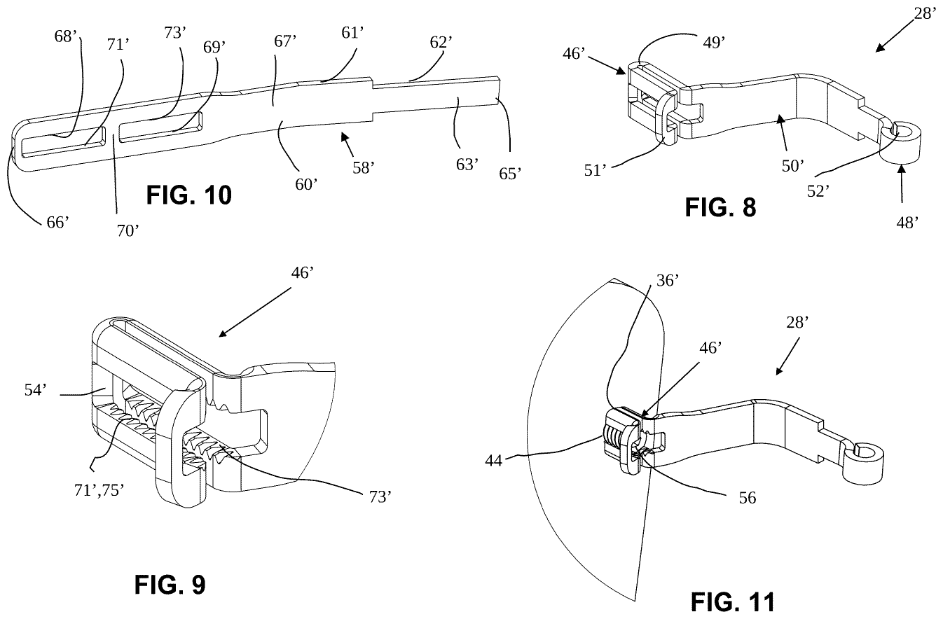

Referring collectively to FIGS. 8 to 11, there is shown an alternative side arm connector 28′, the other alternative side arm connector corresponding to the side arm 26 being a mirror image thereof. Similarly to the side arm connector 28, the side arm connector 28′ is formed of folded sheet metal. The side arm connector 28′ includes a mounting portion 46′, a side arm attachment 48′ and a spacing portion 50′ extending therebetween. The mounting portion 46′ is insertable in an outer mounting aperture 36′ that is similar to the mounting aperture 36, except that the mounting aperture 36′ is generally rectangular with rounded corners, instead of being oval. The mounting portion 46′ is shaped to conform to the shape of an outer mounting aperture 36′, except for clearing the arcuate recesses 44 thereof, so as to be substantially snugly insertable thereinto. The side arm attachment 48 includes an eyelet 52′ usable to pivotally mount thereto a side arm 22 or 24 defining pins configured and sides to engage the eyelet 52′. Such pins are well-know in the art and not further described herein. The spacing portion 50′ is shaped so that the eyelet 52′ is positioned laterally outwardly relative to the outer mounting apertures 36′, so that the side arms 22 and 24 are positioned laterally outwardly relative to the lenses 16 and 18. The connector 28′ is also flared opposed to the base 49′ thereof and thus defines a flange 51′ that may, in some embodiments, abut against the lens 18, or at least prevent the connector 28′ from being fully inserted in the outer mounting aperture 36′.

To manufacture the side arm connector 28′, a substantially planar connector blank 58′ is used. The connector blank 58′ defines opposed connector blank first and second surfaces 60′ and 62′ and a connector blank side edge 61′ extending therebetween. The connector blank 58′ is substantially elongated and defines blank first and second ends 65′ and 66′. A pair of longitudinally spaced apart substantially rectangular and longitudinally extending apertures 68′ and 69′ extend between the connector blank first and second surfaces 60′ and 62′. The first aperture 68′ extends from adjacent the blank second end 66′ towards the blank first end 65′, and the second aperture 69′ extends from adjacent the end of the first aperture 68′ towards the blank first end 65′. A separation segment 70′ extends between the first and second apertures 68′ and 69′. The first and second apertures are each delimited respectively by first and second apertures peripheral surfaces 71′ and 73′, each extending between the first and second surfaces 60′ and 62′. The connector blank 50′ defines an eyelet forming portion 63′ at the blank first end 65′ and an intermediate section 67′ between the eyelet forming portion 63′ and the second aperture 69′.

To form the side arm connector 26′ from the connector blank 58′, one curves the eyelet forming portion 63′ to define the eyelet 52′, which is generally hook-shaped, and bends the connector blank 58′ in the intermediate section 61′ at about 80-95 degrees, similarly to the first bend 76. Also, the mounting portion 46′ is formed by folding the blank 50′ over itself so that the first and second apertures 68′ and 69′ are in register with each other, followed by bending the resulting structure away from the eyelets 52′ to form the mounting portion 46′. This last bend is performed in register with the second aperture 69′, so that after bending, the second aperture 69′ is accessible axially, and is similar to the second bend 80 mentioned hereinabove. Also, the blank 50′ is similarly bent at the blank second end 66′ in register with the first aperture 68′ to also provide axial access thereto.

The first and second apertures peripheral surfaces 71′ and 73′ are tapped once the folding process is completed, to provide threads 75′, similar to the threaded structure of the side arm connector 28. Therefore, a threaded recess 54′ is also formed in the side arm connector 26′, but in a manner that differs from the manner in which the threaded recess 54 is formed. The threaded recess 54′ is terminated by the separation segment 70, which limits axial movements of the threaded fastener 56 used to secure the side arm connector 26′ to the lens 14.

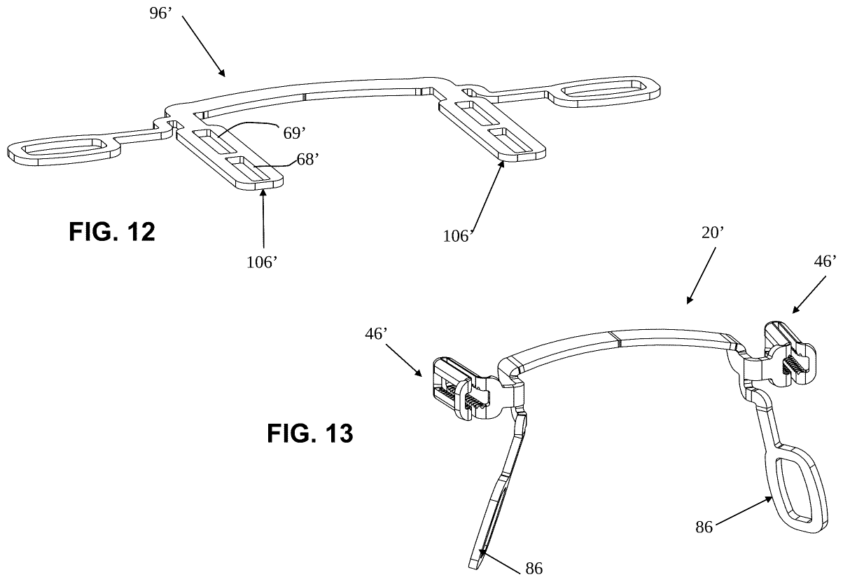

As seen in FIG. 12, a similar attachment portion 46′ can be used in an alternative bridge 20′, which has a structure similar to the structure of the bridge 20, except that the mounting portions 46 are replaced by the mounting portions 46′. The bridge 20′ is therefore manufactured similarly to the bridge 20, except that the bridge blank 96′, shown in FIG. 13, includes an alternative connecting section 106′ similar in structure to the portion of the connector blank 50′ used to form the connecting section 46′.

While the present document describes in details components made of sheet metal, other metal stock such as steel rods (for example between 1 and 2 mm diameter stainless steel) could be formed into a unitary piece which can also achieve a substantially similar result to the sheet metal.

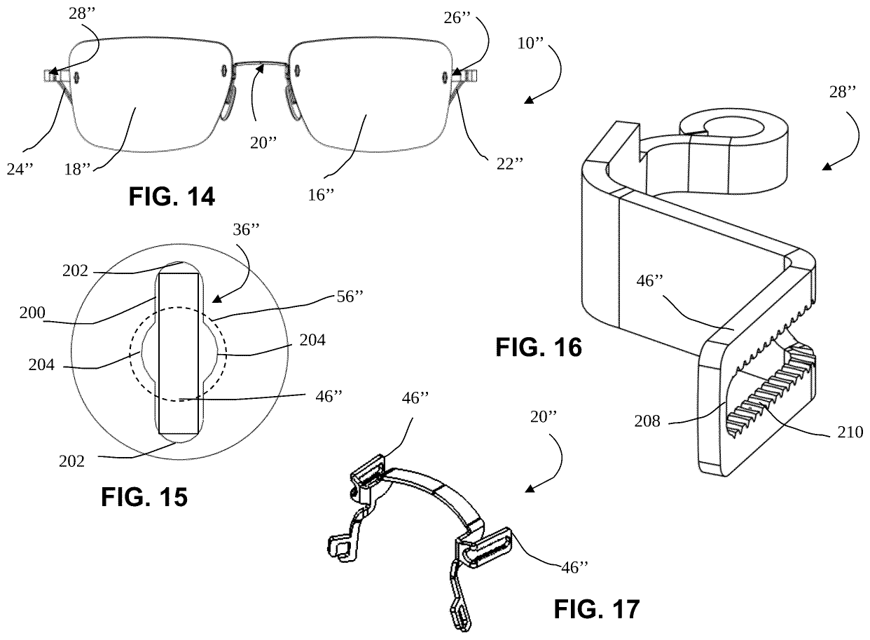

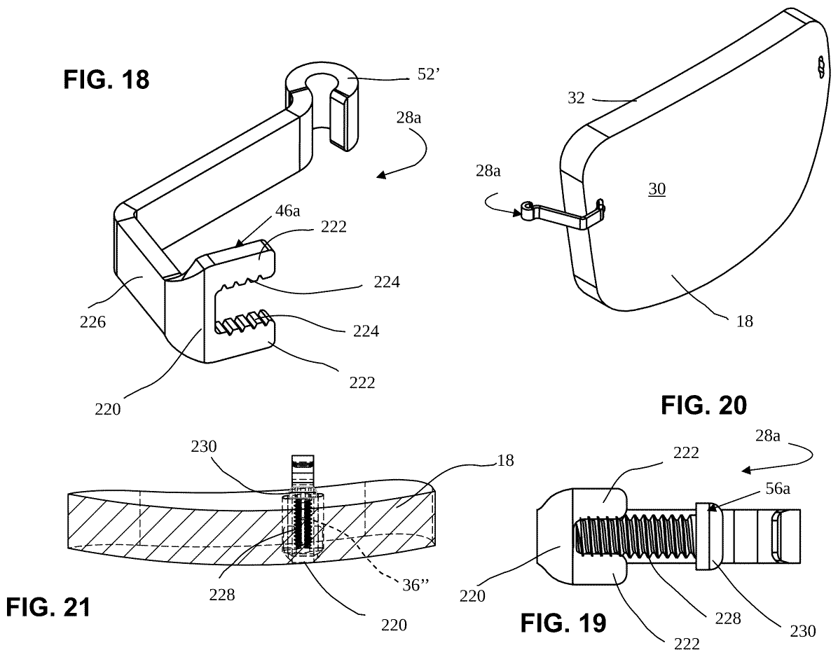

Referring collectively to FIGS. 14 to 17, there is shown an alternative pair of eyeglasses 10″ similar to the eyeglasses 10. The eyeglasses 10″ include a pair of lenses 16″ and 18″ provided in a substantially side-by-side relationship relative to each other. A bridge 20″ extending between the lenses 16″ and 18″, and side arms 22″ and 24″ are each mounted to a respective one lenses 16″ and 18″ through a respective side arm connector 26″ and 28″. As with the eyeglasses 10″, the side arm connectors 26″ and 28″ and the bridge 20″ are made of a single unitary piece of folded metal. The side arm connectors 26″ and 28″ are for example similar to either of the side arm connectors 26 and 28 or 26′ and 28′, and the bridge and the bridge 20″ is for example similar to the bridge 20 or 20′.

The major difference between the components of the eyeglasses 10″ relative to the components previously described resides in the manner in which the side arm connectors 26″ and 28″ and the bridge 20″ are secured to the lenses 26″ and 28″. Since the side arm connectors 26″ and 28″ and the bridge 20″ are secured to the lenses 16″ and 18″ in a similar manner, only attachment of the side arm connector 28″ to the lens 18″ is described in details herein, with the understanding that the bridge 20″ and side arm connector 26″ are similarly secured to the lenses 16″ and 18″.

As seen in FIG. 15, the mounting aperture 36″ is of generally oval shape as includes an elongated slot 200 with rounded ends 202, for example semi-circular ends 202, that is easily formed by moving a cylindrical drill bit from one end of the slot 202 to the other. At a position intermediate the ends 202, for example midway therebetween, a pair of opposed arcuate recesses 204 are formed so as to protrude laterally from the slot 200, so that the arcuate recesses 204 have an outer surface that generally sit at the edge of a common disc. Once again, forming this structure is relatively straightforward as a conventional drill bit can be used to simply drill in the lens. For example, the slot 202 is about 1 mm wide, while the arcuate recesses 204 have a radius of curvature of about 0.8 mm, but other values are within the scope of the invention. In some embodiments, the arcuate recesses 204 are not threaded prior to use, so that the side arm connector 28″ can be secured to the lens 18″ using a self-tapping screw 56″.

The side arm connector 28″ is similar to the side arm connector 28′, except that the mounting portion 46″ thereof is formed of a single thickness of sheet metal, instead of requiring folding of sheet metal over itself. Indeed, the mounting portion 46″ is formed by simply bending a blank in register with one end of an elongated aperture formed in the sheet metal, so that axial access to this elongated aperture 208 is provided. Threads 210 are formed axially along the thickness of the sheet metal, as in the side arm connector 28′. In other words, the side arm connector 28″ is similar to the side arm connector 28′ from which any portion of the blank 58′ seen in FIG. 10 between the second end 66′ and separation segment 70′ has been removed. The threads 210 can be tapped after bending, or preformed through laser cutting the sheet metal prior to bending. Therefore, methods of manufacturing the side arm connector 28″ are similar to manufacturing the side arm connector 28′, except for omission of the folding step in which the blank 58′ if folded over itself at the second end 66′. A similar attachment portion 46″ can be used in the bridge 20″, which has a structure similar to the structure of the bridge 20′, except that the mounting portions 46′ are replaced by the mounting portions 46″.

It should be noted that in this embodiments, it is not required that the shapes of the slot 202 and mounting portion 46″ be the same. In other words, the sheet metal from which the mounting portion 46″ is formed can keep its relatively rectangular profile, as seen from the front, even if the slot 202 is oval. This is because the mechanical coupling that prevents the mounting portion 46″ from exiting the slot 202 is created by engagement of a screw 56″ mounting the mounting portion 46″ with the outside of the arcuate recesses 204. The slot 202 is elongated mainly to prevent the mounting portion 46″ from rotating about the axis of this screw 56″.

In some embodiments, the side arm connectors 26″ and 28″ and the bridge 20″ are laser cut from a hardened stainless steel sheet of 1 mm (or less) gauge, and the elongated slot 202 has a length of 3 mm or more. In this method, the sheet metal thread 210 is laser cut directly into a flat sheet of metal, and only the thin edge of the sheet metal is threaded as the threading does not involve either of the flat surfaces of the sheet metal. Therefore, the mounting portion 46″ is first entirely manufactured on a 2D surface by laser cutting, followed by formation of a few bends, which is a highly simplified manufacturing process when compared to many conventional manners of manufacturing connections with eyeglasses lenses, which typically require at least one of welding, folding or gluing. In the illustrated embodiments, no part of the single layer mounting portion 46″ contacts either the front or rear face of the lens. Furthermore the threaded edge of the sheet metal forms a “female” threaded part, which receives the “male” screw.

This new slot configuration increases surface area and quality of the threading in the lens. After extensive stress tests, it was determined that the threading on the lens, although strong enough for the use case, has the weakest tensile strength and therefore is the weak link of the assembly. Increasing the percentage of thread on the lens by thinning the amount of metal that is threaded has a drastic impact on the solidity and resistance of the assembly.

Also, the proposed assembly has less visual weight and is sleeker than prior art frameless eyeglasses components as the metal part is much thinner than conventionally. This also increases the field of view, which is important in eyewear. It is also easier to mount the end piece flush on the front face of any thickness of lens.

In other embodiments, a wire rod is used instead of sheet metal, the wire rod being threaded along one external edge and folded over itself to form opposed threaded surfaces for receiving a screw therebetween.

While frames and frame components (such as rimless frame components) are generally produced in an eyeglass frame manufacturing facility with specialized equipment, the other part of an eyeglasses assembly consists of a person's personalized prescription lenses, generally now made of plastic, and shaped and processed by either a retail optician or optical laboratory. The completed eyeglass frame is an amalgam of a factory-finished part with a part made by a differently-equipped retailer. The equipment in such facilities is rather different than in an eyeglass frame factory. Typical equipment in an optician's shop or laboratory might include a CNC, machine which can shape and (in the case of rimless) mill required slots and holes in the lenses. Generally the cutting tool (drill bit) used to process holes in lenses will have a 1.00 mm diameter. Therefore the thinnest detail such a drill can produce is defined by the diameter of the drill. Finding reliable ways to attach prescription lenses to rimless components that are both simple enough for a retailer to reliably and efficiently assemble is a challenge, given the aesthetic(small size)/strength constraints. Generally rimless frame drill holes and slots have a simple round shape and sometimes an elongated slot. The proposed eyeglasses 10″ includes a drill detail as described which involves a primary receiving hole or slot to receive the profile edge of either a rod or sheet metal profile edge. This hole or slot generally conforms to the minimum thickness of the intra-lens frame component. A secondary round drill hole substantially larger than the primary hole or slot is drilled contiguously with it.

Very often, rimless frames formed of sheet metal or rod (non-welded, folded only) will rely simply on a compressive fit with or without glue, and not have any threaded assembly. These are often subject to failure, but the advantage of making frames this way is so important that even sub-optimal assemblies have been on the market for many years A new and better way to assemble these components is very significant. Drilling the lens with the substantially wider secondary hole (compared to the primary hole or slot) will generate a greater % of well-formed thread in the plastic lens which will ensure a stronger assembly than would be the case where the drill slot has a uniform width.

In rimless eyeglasses, the metal components generally consist of 3 parts (2 end pieces and a central bridge) and these parts have an external (to the lens) portion and an intra-lens projection. Sometimes the projection is a bolt which is either welded to or passes through a hole in the outer component. There are several methods to fix the frame component to the lens using standard nuts and bolts or compression rivets of plastic and sometimes glue or simply compression. In some cases when rod stock is used, the rod itself can have a threaded end (a conventionally threaded rod can be threaded with a die) and it becomes a male bolt. A nut can be fixed at the opposite end, generally external to the slot.

In both the flat sheet metal stock and metal rod stock rimless frame components described hereinabove, the frame components are made by bending only (no weld) and are unconventionally threaded to become female receiving members, along their respective edges only.

Furthermore, in other embodiments, the screw 56″ could have a head and the lens could not be threaded, rather the screw would engage with the threaded edge of the metal part within the drill hole, and the head of the screw would close on the external face of the lens. For example the secondary hole could be large enough to let the major diameter of the screw pass within snugly, but without creating threads in the lens necessarily.

Often, hardened stainless steel sheet metal frames (or rimless frame components) are formed from sheet metal that is 0.6 mm thick, (between 0.5 mm and 0.8 mm being used in some instances). Due to the constraints of lab equipment used to drill holes and slots in lenses, the minimum diameter of the milling tool is usually 1 mm. Below this, drill bits tend to break easily and the process can be slower. Occasionally a 0.8 mm drill tool is used. If a sheet metal frame component (the intralens component) is made by a single layer of sheet metal of less than the width of the minimal drill slot, there will be a mismatch whereby the frame component is narrower than the slot. A gasket or glue have been used to restrain the parts from being loose. But generally the intralens part will be a folded double layer, so it is effectively sized to match the width of the slot.

The proposed drill slot/hole configuration presented allows for 2 or 4 points of contact which secures the metal part on top and the bottom of the drill slot 200. The opposite ends of the milled slot match the diameter semicircular profile of the mill. The wider secondary hole (contiguous with the slot) allows a bolt or screw to lock the assembly (threaded into the metal sheet along its long edge). The threaded bolt or screw 56″ can secure the parts by either fitting into a drill hole which matches its major Diameter (and not thread into the lens slot), and secure the opposite end by its head, or a set screw can fit into a drill hole which is sized to be the same as the minor diameter of the screw, whereby the hole is the correct pilot hole size and thus “co-thread” the lenses and metal frame component without the need for a “headed” screw.

Another feature of this drill slot 200 design (which mates a minimal drill slot width with a larger secondary hole) is that it allows a headed screw or a set screw to reach the metal components when the metal components are shorter than the thickness of the prescription lens.

In rimless frames, by convention, the standard minimum lens thickness is 2 mm. There are situations where this thickness can vary from 1.8 to over 6 or 7 mm. In a sheet metal rimless design, whereby the intra-lens portion is a single unfolded largely rectangular profile of sheet metal, it is advantageous in some designs that this intra lens portion not be longer than 2 mm, or it could protrude from the opposite lens face, which is undesirable. In such cases, where the lens slot is of uniform width, and where the lens thickness is greater than the intralens portion of the sheet metal component, it will be difficult to engage and register the screw into the receiving slot of the metal part. The slot being much longer than the width of the screw, there is an advantage in having the wider secondary hole, which acts as a guide path for the screw, to properly engage into the metal component.

The proposed unfolded single layer sheet metal rimless design is effectively the best way to make a completely “flush” mounting to the front surface of the lens, whether we actually cross thread the lens and metal. For example, this could also be achieved either that way or with a regular bolt. A feature that creates many advantages is the combination of the single layer of sheet metal with the edge threading and the larger secondary hole.

More specifically, referring collectively to FIGS. 18 to 21, there is shown yet another embodiment of a side arm connector 28a including an alternative mounting portion 46a. The other side arm connector is similar, and an alternative bridge (not shown) may also mount to a lens using a similar mounting portion 46a. The side arm connector 28a is similarly to the previously described ones manufactured by bending blanks that have been cut or stamped from stock sheet metal. In opposition to the side arm connector 28″ for example, the side arm connector 28a is mounted from a front surface 30 of the lens 16 towards the rear surface 32 of the lens.

The side arm connector 28a includes a generally U-shaped mounting portion 46a insertable in an outer mounting aperture 36″ described above. The mounting portion 46a is substantially U-shaped and defines a base 220 and a pair of arms 222 extending from the base 220. The arms 222 are generally parallel to each other and define facing threaded inner surfaces 224 for threading a threaded fastener 56a thereto, between the arms 222 along their long axis. The arms 222 are in some embodiments relatively short so as to not protrude from the mounting aperture 36″ when the side arm connector 46a is mounted thereinto. An L-shaped spacing segment 226 extends from the base 220, typically about perpendicularly thereto, for example at an angle of between 80 and 100 degrees. The spacing segment 226 is terminated by an eyelet 52′. The spacing segment 226 is configured so that the eyelet 52′ will be located behind the lens 18 and laterally offset relative thereto when the side arm connector 28a is mounted to the lens 18. In other words, with the mounting portion 46a inserted in the mounting aperture 36″, the spacing segment 226 first extends across the lens front surface 30 to protrude laterally therefrom, and then bends towards the lens rear surface to protrude at the back of the lens 18.

The threaded fastener 56a includes a threaded shaft 228 from which a head 230 extends, the head 230 having a larger diameter than the threaded shaft 228. In some embodiments, the threaded shaft 228 has a diameter small enough that the mounting aperture 36″ is not engaged. In other words, the threaded fastener 56a is not threaded to the lens 18 and slides along the arcuate recesses 204, instead of engaging them. However, the head 230 is large enough to abut against the lens rear surface 32 when the threaded fastener 56a is fully screwed to the mounting portion 46a. Therefore, in this embodiment, the side arm connector 46a is secured to the lens 18 by sandwiching the lens 18 between the head 230 and the spacing segment 226.

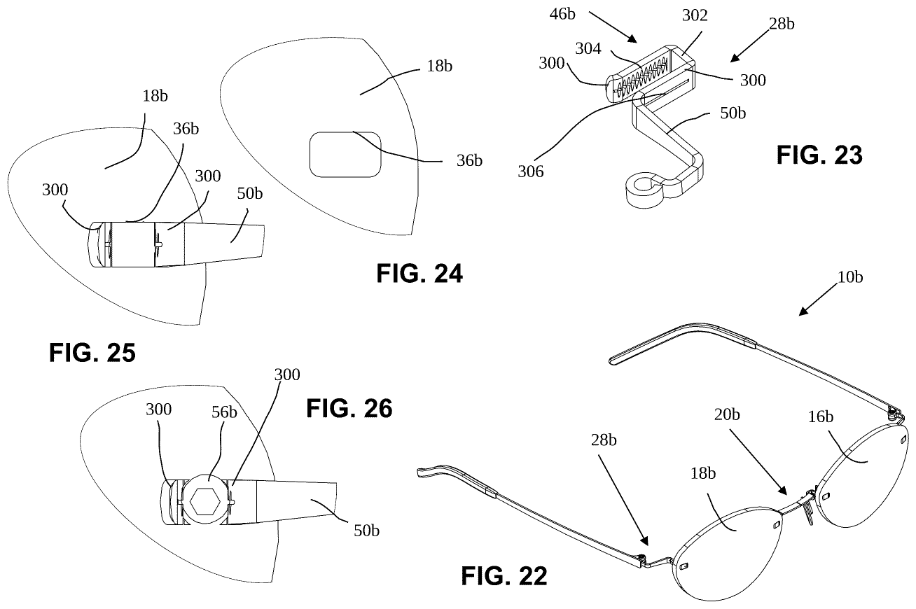

Referring collectively to FIGS. 22 to 26, there is shown yet another pair of eyeglasses 10b in which various components are mounted in yet another alternative way. The eyeglasses 10b include an alternative side arm connector 28b including an alternative mounting portion 46b. The other side arm connector is similar, and an alternative bridge 20b may also mount to lenses 16b and 18b using a similar mounting portion 46b. The side arm connector 28b is similarly to the previously described ones manufactured by bending blanks that have been cut or stamped from stock sheet metal.

The side arm connector 28b includes a generally U-shaped mounting portion 46b insertable in a mounting aperture 36b. The mounting aperture 36b is similar to the above-described mounting apertures, except that it is relatively wider, and therefore has a rectangular configuration with a relatively large width to length ratio, for example and non-limitingly, between 1.5 and 2.5. The mounting portion 46b is substantially U-shaped when viewed from above, with a pair of parallel threaded portions 300 linked to each other by a linking portion 302, which is typically perpendicular to the threaded portions 300. The spacing portion 50b extends from one of the threaded portions 300, opposed to the linking portion 302. Therefore, the side arm connector 28b is similar to the side arm connector 28′, but has a wider mounting portion 46b.

Threads 304 are formed on the surface of the threaded portions 300, facing each other across the gap created by the linking portion 302. Thus, the threads 304 on the surface of sheet metal used to manufacture the connector 28b. In some embodiments, a slit 306 extends longitudinally along the threaded portions 300, midway in the height of the threads 304. The slit 306 is used to guide the threaded fastener 56b that will be used to secure the mounting portion 46b to the lenses 16b and 18b. The threaded portions 300 may be flared laterally outwardly opposed to the linking portion 302, so that the slit 302 is exposed from the rear of the side arm connector 28b.

To mount the mounting portion 46b to a lens, for example lens 18b as illustrated in the drawings, one inserts the linking portion 302 through the mounting aperture 36b, with the threads 304 opening toward the back of the lens 18b. Once the linking portion 302 is flush with the lens 18b, or only protrudes slightly therefrom, a substantially square empty space remains, delimited by the lens on two sides thereof, and by the threaded portions 300 on the other to sides. The threaded fastener 56b can then be screwed to the threaded portions 300 by engaging the threads 304 and the lens 18b. The slits 306 guide the threaded fastener 56b during this process, as the depth of the threads 306 prevents the threaded fastener 56b from engaging the threads 306 at other locations without using more force, as the slits 306 effectively create a small depression in the channel in which the threaded fastener 56b is guided.

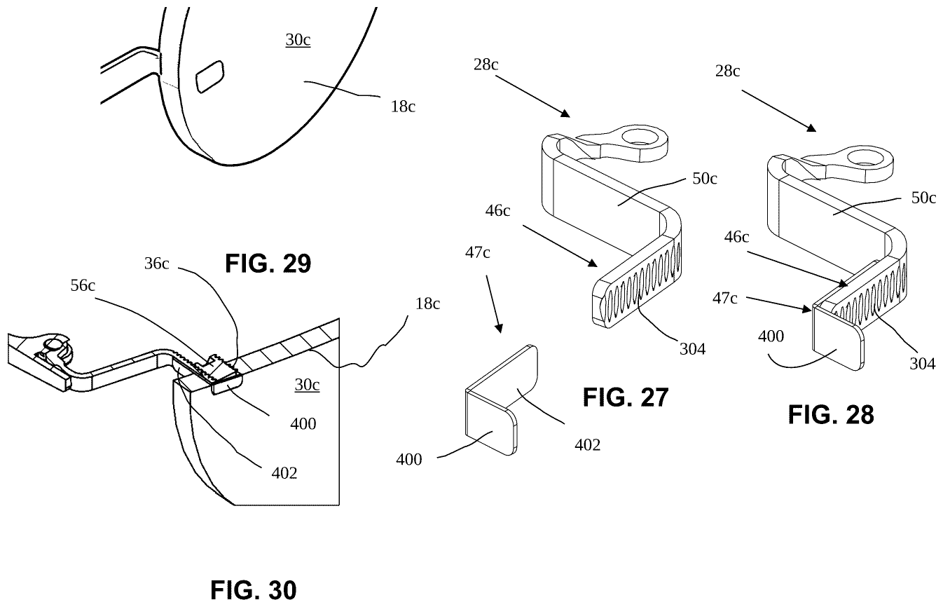

Referring collectively to FIGS. 27 to 30, there is shown yet another side arm connector 28c. The side arm connector 28c is similar to the other side arm connectors described above, except that its mounting portion includes a mounting portion main component 46c, that extends integrally as a single piece of material from the spacing portion 50c, and a mounting portion auxiliary component 47c manufactured separately from the remainder of the side arm connector 28c. The side arm connector 28c is insertable in a generally rectangular or square mounting aperture 36c formed in a lens 18c, similar to the mounting aperture 36b described above.

The mounting portion main component 46c is generally rectilinear and plate-shaped. The mounting portion main component 46c defines threads 304 on its free surface, which faces inside the mounting aperture 36c when the mounting portion main component 46c is operatively mounted thereinto. The mounting portion main component 46c is thus present and provides threads on only on one of the four sides of the mounting aperture 36c. The threaded fastener 56c used to secure the side arm connector 28 c to the lens 18 c therefore engages the other 3 sides of the mounting aperture 36c.

The mounting portion auxiliary component 47c is used to obstruct the front of the mounting aperture 36c. The mounting portion auxiliary component 47c is configured to be substantially flush with the front surface 30c of the lens 18c when assembled with the mounting portion main component 46c. More specifically, the mounting portion auxiliary component 47c is typically made of a bent elongated strip of sheet metal defining a front portion 400 and a side portion 402 that extend generally perpendicularly to each other, for example at an angle of between 80 degrees and 105 degrees.

Advantageously, in some embodiments, the mounting portion auxiliary component 47 c is made of relatively thin sheet metal, for example between 0.1 and 0.3 mm thick. These embodiments are advantageous for at least the following reasons. First, due to their small thickness, they are relatively easily bent when mounted to a lens 18c to conform to the angle between the longitudinal axis of the mounting aperture 36c and the lens front surface 30c, which varies from lens to lens. Therefore, the same component can be used with a large variety of lenses 18c having different dimensions, thicknesses and radii of curvature. Also, due to its thinness, the radius of curvature at the junction between the front portion 400 and the side portion 402 can be relatively small, which when seen from afar, is almost indistinguishable from a perfect ideal angle between two planes.

Finally, the front portion 400 is typically positioned to that its front face is substantially flush with the front surface 30c, substantially without discernible recesses or protrusion adjacent the junction between the front portion 400 and the front surface 30c. Since the lens 18c may be relatively thin, and since threads used in the frameless eyeglasses business typically have a pitch of around 0.5 mm, for example 0.45mm, having a thin front portion 400 allows one to have enough full thread turns to secure properly the threaded fastener 56c to the lens 18c.

In some embodiments, the mounting portion auxiliary component 47c is welded, glued, or otherwise secured to the mounting portion main component 46c prior to assembly to the lens 18c. In other embodiments, the mounting portion auxiliary component 47c is positioned in the mounting aperture 36c between the peripheral edge thereof and the mounting portion main component 46c when the eyeglasses are assembled. In this latter case, in some embodiments, the mounting portion auxiliary component 47c is maintained in the mounting aperture 36c by friction. In both cases, the side portion 402 extends generally parallel to the mounting portion main component 46c, opposed to the threads 304. While this specific manner of mounting a component to a lens has been illustrated with respect to a side arm connector 28c, a bridge similar to the above-described bridges but differing in their mounting portions can also be mounted similarly to lenses.

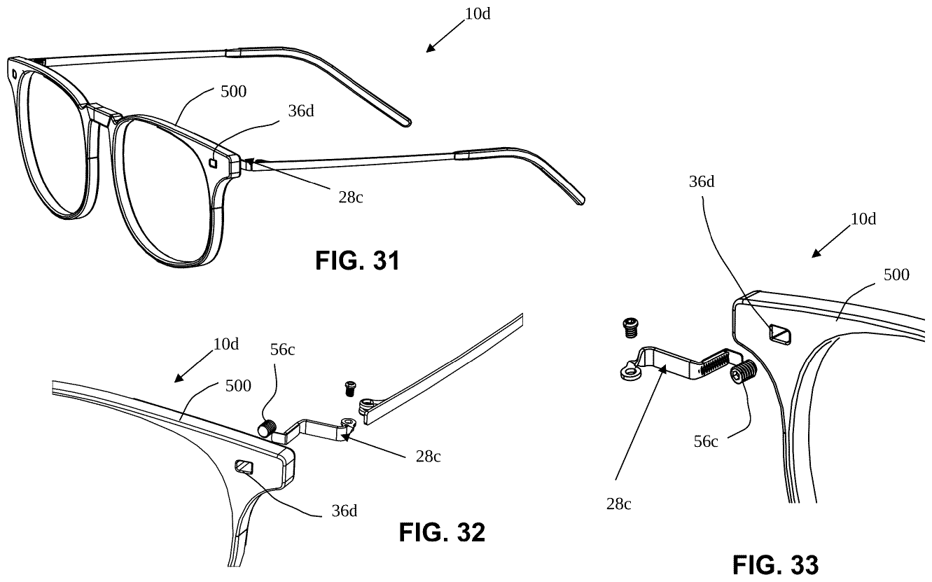

In yet other embodiments, the side arm connectors described in the present document, and other similar components, such as complete side arm assemblies or bridge components, may be mounted to a frame 500 of framed eyeglasses 10d, as seen collectively in FIGS. 31 to 33. A mounting aperture 36d is provided in the frame 500. For example the frame 500 is manufactured using stock material, such as stock polymer sheets or stock sheet metal, but similar frames manufactured any other suitable technology can be used. Mounting of the side arm connector 28c to the frame 500 is illustrated in the drawings, but all the other manners of mounting a component in an aperture described in the present documents are usable. The only difference between the attachment of components shown in FIGS. 31 to 33 with respect to the previously described attachment methods is that the component, for example the side arm connector 28c, is mounted in a mounting aperture 36d provided in the frame 500, instead of being mounted in an aperture formed in a lens.

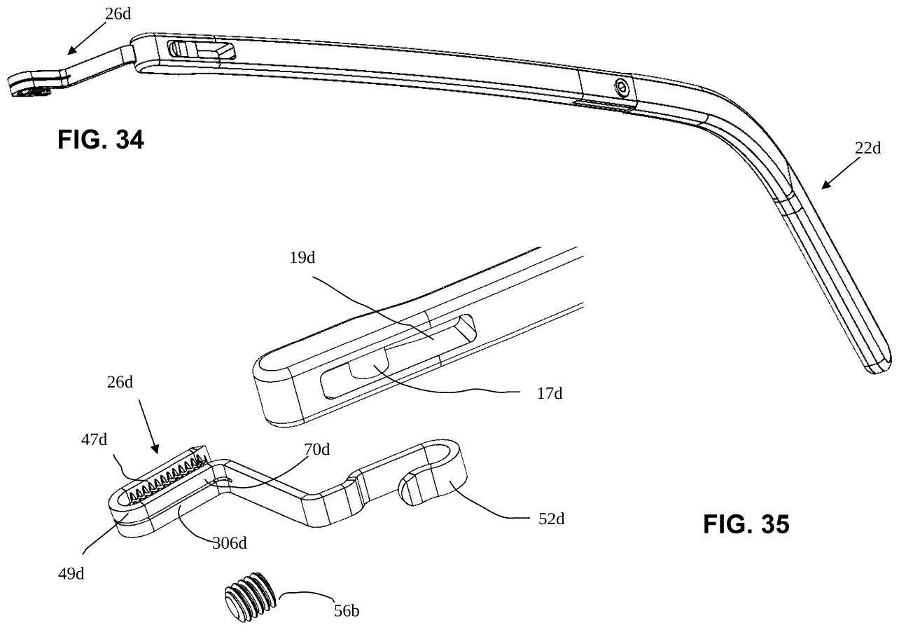

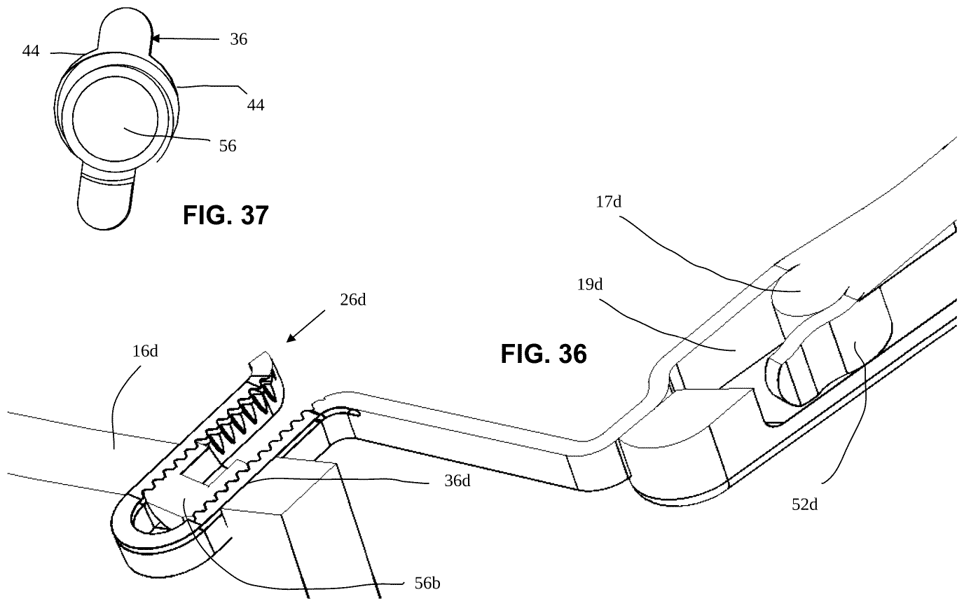

FIGS. 34 to 36 illustrate collectively yet another side arm connector 26d and side arm 22 assembly. The side arm connector 26d is similar to the side arm connector 28b, except that the slit 306d extends along the whole rectilinear portion of the arms 47d and base 49d of the mounting portion 46d. Therefore, the width and thickness of the portion of the side arm connector 26d that is inserted in the lens 16d can be adjusted by widening or narrowing the slit 306d or spreading or compressing towards each other the arms 47d. This may be advantageous if the outer mounting aperture 36d has been formed in the lens 16d with dimensions that differ slightly from ideal, nominal, dimensions for which the mounting portion 46d is conceived. Indeed, the outer mounting aperture 36d is typically milled in an optician's shop, and the equipment used to do so may form apertures that are either slightly too large or slightly too small. The proposed structure allows one to perform such adjustments without the use of glue or gaskets, with the related advantages mentioned above. A similar mounting portion 46d is also usable in a bridge.

The side arm attachment 52d takes the form of a hook opening towards the lens 16d receiving a pin 17d extending across an aperture 19d formed in the side arm 22d. The side arm attachment 52d is resiliently deformable to allow insertion and removal of the pin 17d into and from the side arm attachment 52d.

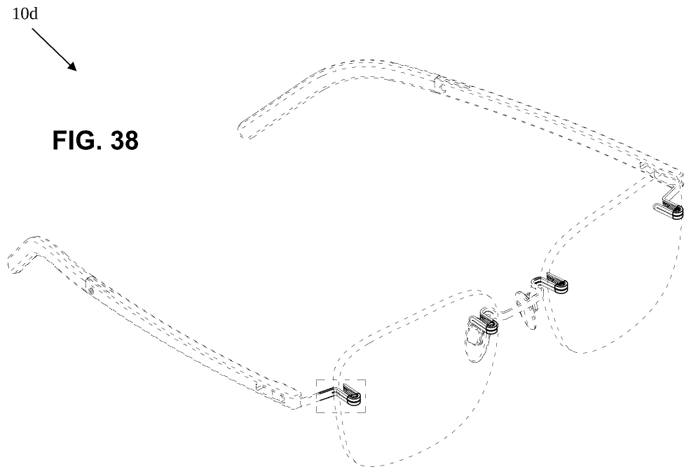

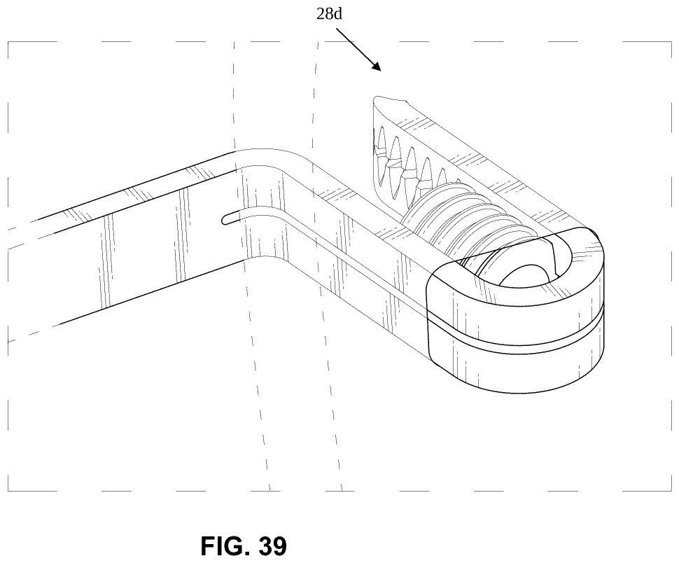

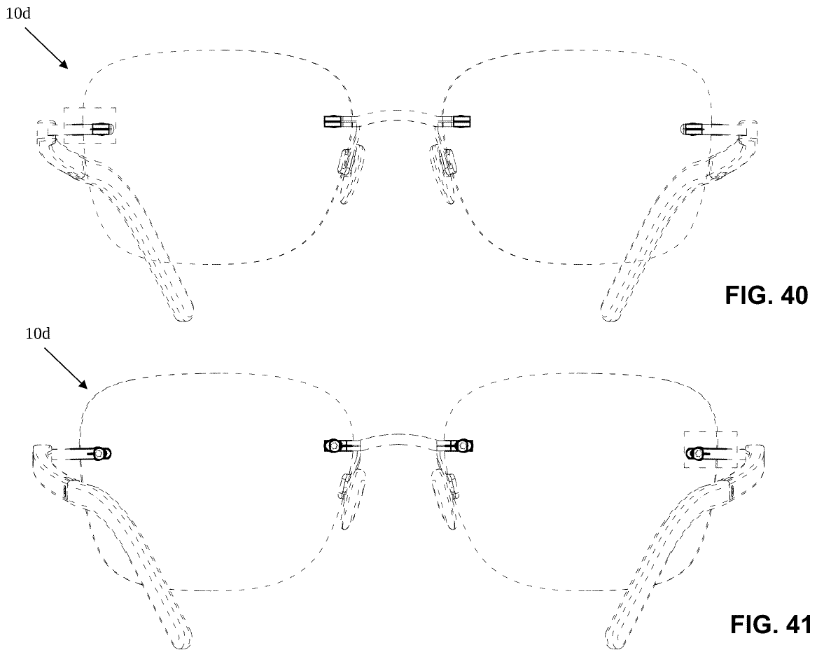

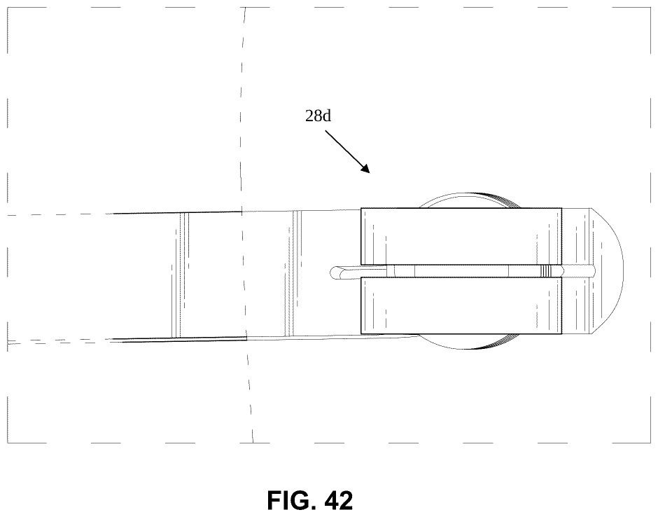

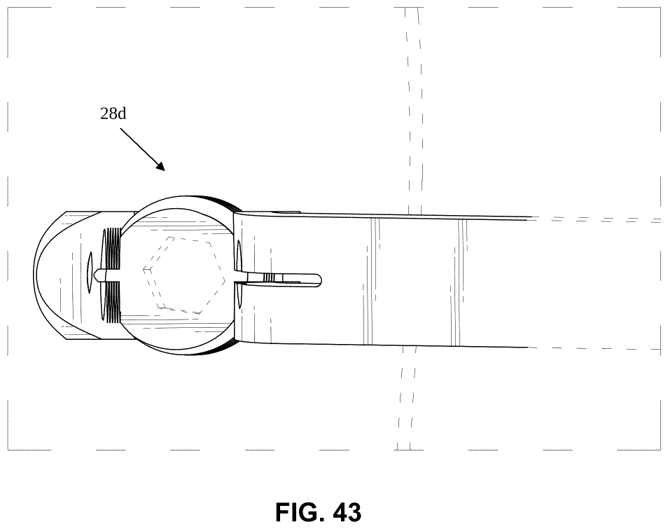

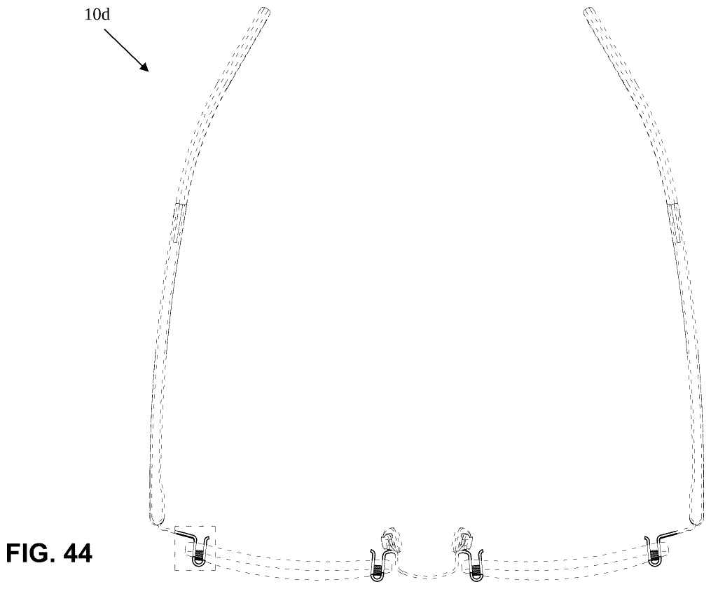

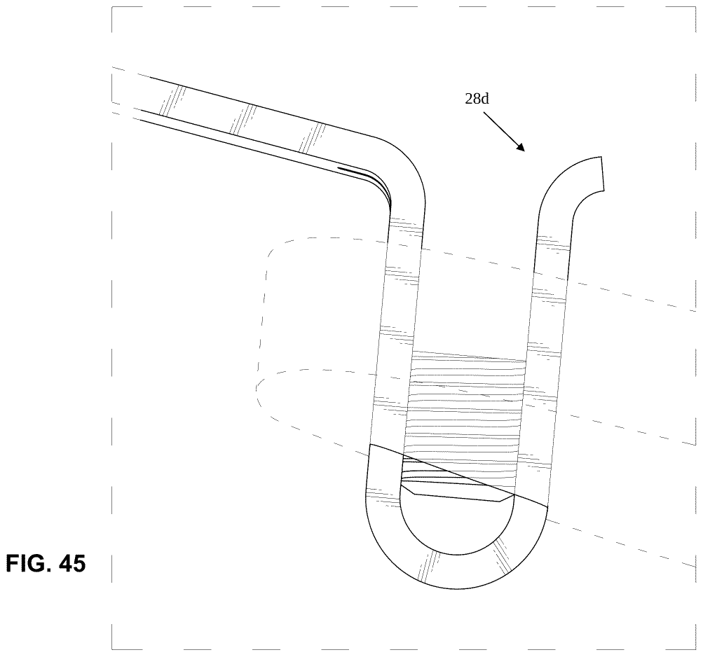

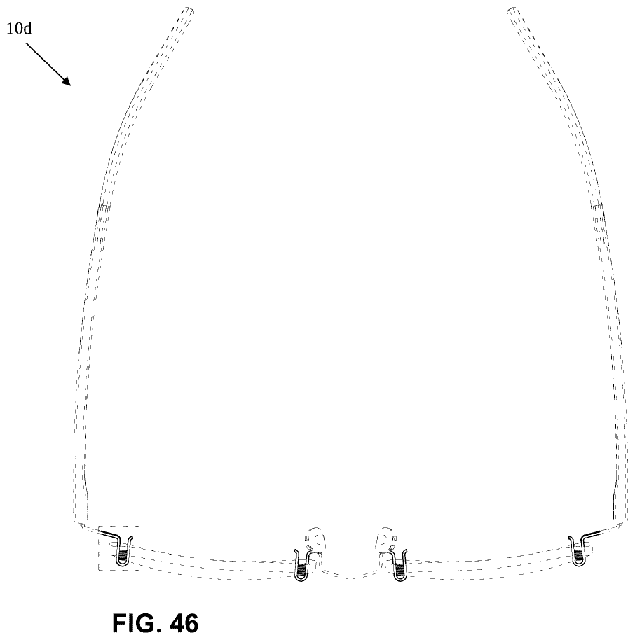

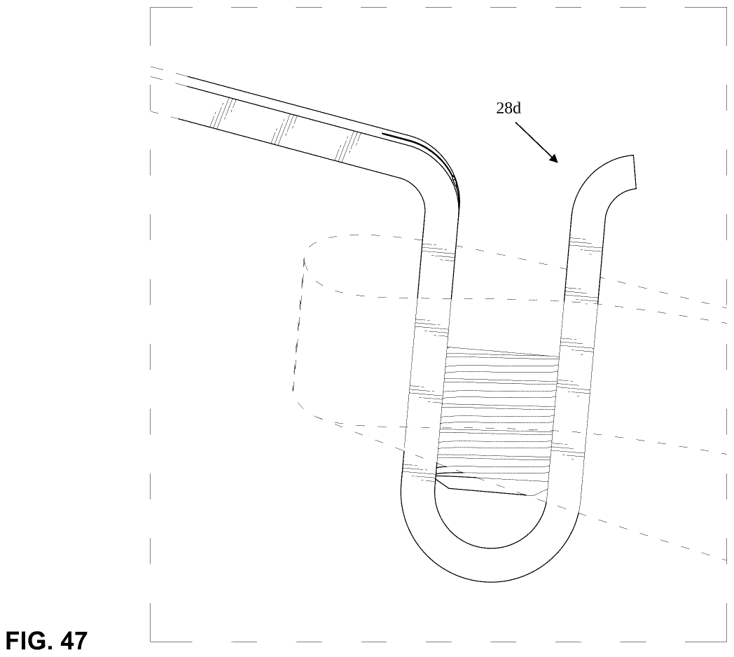

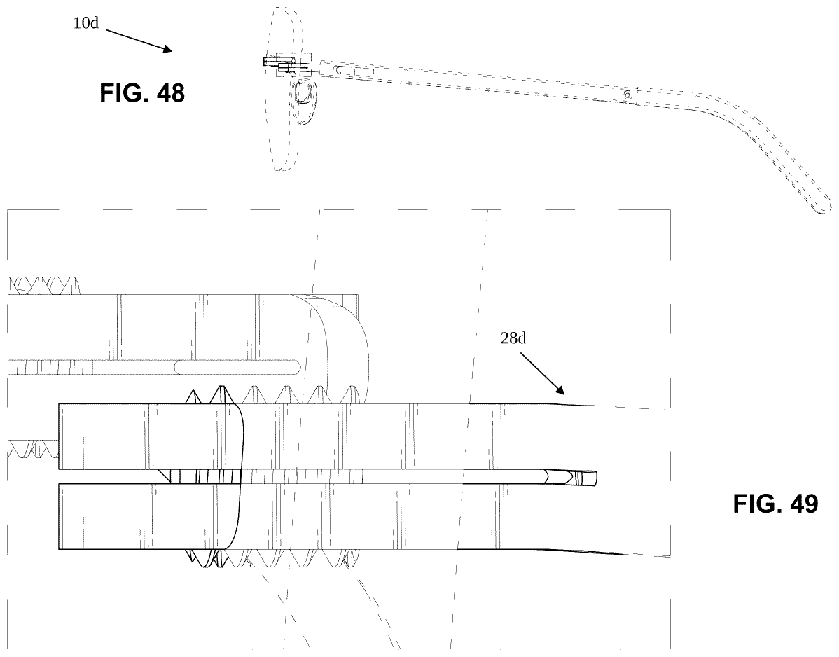

FIGS. 38 to 49 collectively illustrate various aspects of eyeglasses 10d incorporating the side arm connector 28d, which similar to the side arm connector 26d.

Although the present invention has been described hereinabove by way of preferred embodiments thereof, it can be modified, without departing from the spirit and nature of the subject invention as defined in the appended claims.

What is claimed is:

1. Frameless eyeglasses, the frameless eyeglasses defining substantially opposed eyeglasses lateral sides, the frameless eyeglasses comprising:
a pair of lenses provided in a substantially side-by-side relationship relative to each other between the eyeglasses lateral sides, each one of the lenses defining a lens front surface and an opposed lens rear surface, each one of the lenses defining an inner mounting aperture and an outer mounting aperture extending therethrough between the lens front and rear surfaces, the outer mounting apertures being provided at the eyeglasses lateral sides, and the inner mounting apertures being provided between the outer mounting apertures;
a bridge extending between the lenses and mounted to the inner mounting apertures;
a pair of side arms; and
a pair of side arm connectors each mounted each to a respective one of the outer mounting apertures, each of the side arms being mounted to a respective one of the side arm connectors;
wherein the side arm connectors or the bridge or both the bridge and the side arm connectors are made of a single unitary piece of folded metal.

2. The frameless eyeglasses as defined in claim 1, wherein the side arm connectors and the bridge are each made of a single unitary piece of folded metal.

3. The frameless eyeglasses as defined in claim 2, wherein the side arm connectors and the bridge define mounting portions secured in a respective mounting aperture selected from the inner and outer mounting apertures, each side arm connector defining one of the mounting portions and the bridge defining a pair of spaced apart mounting portions.

4. The frameless eyeglasses as defined in claim 3, wherein the mounting portions are secured in the respective mounting apertures in a glueless and gasketless joint.

5. The frameless eyeglasses as defined in claim 3, wherein the mounting portions directly contact the lenses in the respective mounting apertures.

6. The frameless eyeglasses as defined in claim 3, wherein the mounting portions define thread segments and wherein the mounting portions are secured in the respective aperture through threaded fasteners engaging both the thread segments and the lenses.

7. The frameless eyeglasses as defined in claim 6, wherein the fasteners engage the thread segments along a first circumferential portion of the fasteners and engage the lenses along a remainder of a circumference of the fasteners.

8. The frameless eyeglasses as defined in claim 6, wherein the mounting portion is made of folded sheet metal defining two sheet metal faces and a sheet metal edge extending therebetween, the thread segments being formed in one of the sheet metal faces.

9. The frameless eyeglasses as defined in claim 6, wherein the mounting portion is made of folded sheet metal defining two sheet metal faces and a sheet metal edge extending therebetween, the threads being formed in the sheet metal edge.

10. The frameless eyeglasses as defined in claim 6, wherein the mounting portion is substantially U-shaped and defines a pair of substantially parallel arms extending through the respective mounting aperture and a base extending therebetween, the base being in front of the lenses.

11. The frameless eyeglasses as defined in claim 10, wherein the arms flare laterally outwardly opposed to the base.

12. The frameless eyeglasses as defined in claim 10, wherein a slit extends through the mounting portion along the arms and the base.

13. The frameless eyeglasses as defined in claim 1, wherein the inner and outer mounting apertures are each substantially oval shaped.

14. The frameless eyeglasses as defined in claim 3, wherein the inner and outer mounting apertures are each shaped as an intersection of an oval shaped main portion and a disc-shaped fastener receiving portion intersecting the main portion, and wherein the side arm connectors each define a fastener receiving recess receiving a threaded fastener thereinto, the fastener receiving portion and the fastener receiving recess being concentric.

15. The frameless eyeglasses as defined in claim 3, wherein the inner and outer mounting apertures are each shaped as an intersection of an oval shaped main portion and a disc-shaped fastener receiving portion intersecting the main portion, and wherein the side arm connectors each define a fastener receiving recess receiving a threaded fastener thereinto, the fastener receiving portion and the fastener receiving recess being eccentric relative to each other.

16. The frameless eyeglasses as defined in claim 1, wherein the bridge defines a pair of nose pad supports and wherein a nose pad is are attached to each of the nose pad supports.

17. A frameless eyeglasses components kit for assembling eyeglasses defining substantially opposed eyeglasses lateral sides using a pair of lenses, wherein with the lenses provided in a substantially side-by-side relationship relative to each other between the eyeglasses lateral sides, each one of the lenses defines a lens front surface and an opposed lens rear surface, each one of the lenses defining an inner mounting aperture and an outer mounting aperture extending therethrough between the lens front and rear surfaces, the outer mounting apertures being provided at the eyeglasses lateral sides, and the inner mounting apertures being provided between the outer mounting apertures, the frameless eyeglasses components kit comprising:
a bridge mountable to both inner mounting apertures;
a pair of side arms; and
a pair of side arm connectors each mountable to a respective one of the outer mounting aperture, each of the side arms being mountable to a respective one of the side arm connectors;
wherein at least one of the side arm connectors and the bridge is made of a single unitary piece of folded metal.
